(19) United States
(12) Patent Application Publication
(10) Pub. No.: US 2007/0056039 A1
(43) Pub. Date: Mar. 8, 2007

(54) Memory filters to aid system remediation

(76) Inventors: Hormuzd Khosravi, Portland, OR (US); Priya Rajagopal, Worcester, MA (US); Ravi Sahita, Beaverton, OR (US); Uday Savagaonkar, Beaverton, OR (US)

Correspondence Address: INTEL CORPORATION;C/O INTELLEVATE, LLC, P.O. BOX 52050, MINNEAPOLIS, MN, 55402, US

(21) Appl. No.: 11/220,462

(22) Filed: Sep. 7, 2005

(51) Int. Cl. G06F 12/14

(52) U.S. Cl. 726/24

(57) ABSTRACT

The present disclosure relates to providing a remediation scheme for a compromised system and, more specifically, to providing a memory filtration scheme using an isolated partition within a system.

### BACKGROUND

1. Field

The present disclosure relates to providing a remediation scheme for a compromised system and, more specifically, to providing a memory filtration scheme using an isolated partition within a system.

2. Background Information

Malware (a portmanteau of “malicious software”) is any software program developed for the purpose of causing harm to a computer system, or, in this context, alters the behaviour of a program. Malware can be classified based on how it is executed, how it spreads, and/or what it does. The classification is not perfect, however, in the sense that the groups often overlap and the difference is not always obvious.

Two common types of malware are viruses and worms. These types of programs have in common that they are both able to self-replicate; they can spread (possibly modified) copies of themselves. Not every program that copies itself is a virus or worm; for instance, backup software may copy itself to other media as part of a system backup. To be classified as a virus or worm, at least some of these copies have to be able to replicate themselves too, such that the virus or worm can propagate itself. However, these are not the only two types of traditional malware. Other types of malware may include, but are not limited to: wabbits, trojans, backdoors, spyware, various exploits due to bad initial programming, rootkit software, key loggers, or dialers, etc.

Malware may also include software that modifies or was modified to perform a different task that was originally intended. For example, software may be modified to circumvent content protection or Digital Rights Management schemes, allow cheating in video games, etc.

Because viruses were historically the first to appear, the term “virus” is often applied, especially in the popular media, to all sorts of malware. Modern anti-viral software attempt to strengthen this broader sense of the term as their operation is never limited to viruses.

Typical anti-viral software attempts to identify, thwart and eliminate computer viruses and other malicious software (malware). Anti-virus software typically uses two different techniques to accomplish this. The first technique often includes examining (scanning) files to look for known viruses matching definitions in a virus dictionary. The second technique often includes identifying suspicious behavior from any computer program which might indicate infection. Most commercial anti-virus software uses both of these approaches, with an emphasis on the virus dictionary approach.

However, software based anti-viral techniques are frequently ineffective, for a variety of reasons. Some anti-virus software can considerably reduce performance. Users may disable the anti-virus protection to overcome the performance loss, thus increasing the risk of infection.

In another example, it is sometimes necessary to temporarily disable virus protection when installing major updates such as, for example, Windows Service Packs. Having anti-virus protection running at the same time as installing a major update may prevent the update installing properly or at all. A need therefore exists, to detect and attempt to remediate a system that is affected by malware.

### BRIEF DESCRIPTION OF THE DRAWINGS

Subject matter is particularly pointed out and distinctly claimed in the concluding portions of the specification. The claimed subject matter, however, both as to organization and the method of operation, together with objects, features and advantages thereof, may be best understood by a reference to the following detailed description when read with the accompanying drawings in which:

FIG. 1 is a flow chart illustrating an embodiment of a remediation scheme in accordance with the disclosed subject matter; and

FIG. 2 is a block diagram illustrating an embodiment of an apparatus and system in accordance with the disclosed subject matter.

### DETAILED DESCRIPTION

In the following detailed description, numerous details are set forth in order to provide a thorough understanding of the present claimed subject matter. However, it will be understood by those skilled in the art that the claimed subject matter may be practiced without these specific details. In other instances, well-known methods, procedures, components, and circuits have not been described in detail so as to not obscure the claimed subject matter.

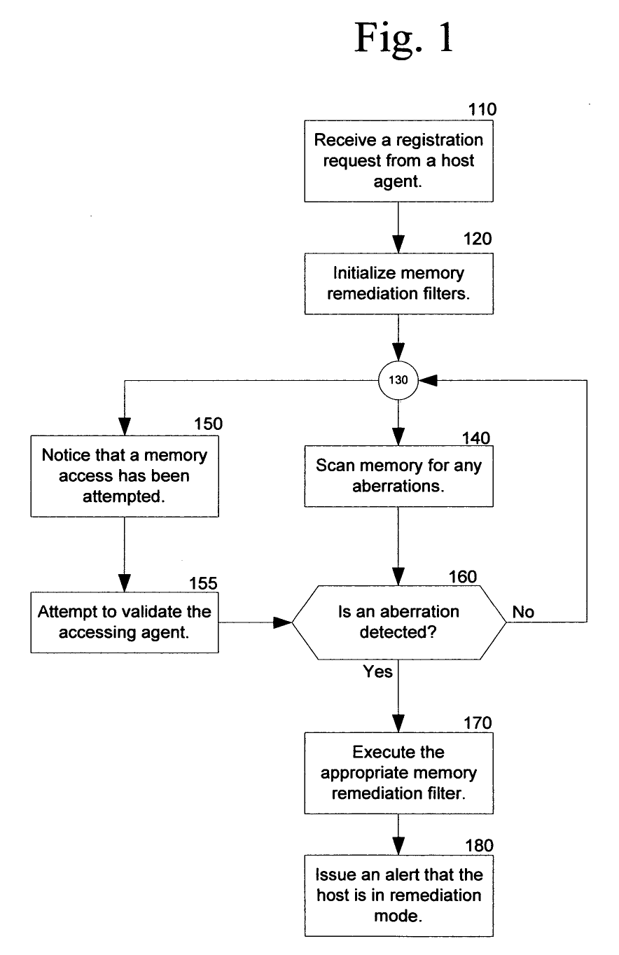

FIG. 1 is a flow chart illustrating an embodiment of a remediation scheme in accordance with the disclosed subject matter. Block 110 illustrates that, in one embodiment, a registration request may be made by or on behalf of a host agent. In this context, a host agent may be any software, hardware, firmware, or combination thereof that is executing on a system, either locally or remotely. In one embodiment, the host agent may execute directly on the main processor of the system.

In another embodiment, the host agent may execute within or as part of a virtual machine. The virtualization of machine resources has been of significant interest for some time; however, with processors becoming more diverse and complex, such as processors that are deeply pipelined/super pipelined, hyper-threaded, on-chip multi-processing capable, and processors having Explicitly Parallel Instruction Computing (EPIC) architecture, and with larger instruction and data caches, virtualization of machine resources is becoming an even greater interest. Many attempts have been made to make virtualization more efficient. For example, some vendors offer software products that have a virtual machine system that permits a machine to be virtualized, such that the underlying hardware resources of the machine appears as one or more independently operating virtual machines (VM).

In one embodiment, the registration request may be received by a service processor that is capable of executing substantially independently of the main system processor. In another embodiment, the registration request may be received by a substantially isolated partition of the system that is hardened against tampering. For example, in one embodiment, the partition may be an embedded operating system under the control of either a service processor or a secondary processor. In one embodiment, the partition may include hardware, firmware, software, elements or a combination thereof. In another embodiment, the partition may execute on the main system processor.

In yet another embodiment, the registration request may be received by a Virtual Machine Monitor. Typically, a Virtual Machine Monitor (VMM) may be a thin layer of software running on a computer and presenting to other software an abstraction of one or more VMs. In one embodiment, the VMM may be an application running within a host operating system. In one specific embodiment, the VMM may include 3 main portions: a kernel mode application or set of applications running on the host operating system, a set of drivers in the host operating system, and a co-operative kernel that substantially or partially replaces the host kernel when the VM is running. In an alternate embodiment, the VMM may be a layer of basic code executing directly on the host hardware. Each VM, on the other hand, may function as a self-contained platform, running its own operating system (OS), or a copy of the OS, and/or a software application. Software executing within a VM is collectively referred to as “guest software” or “guest OS”. Some commercial solutions that provide software VMs include VMware, Inc. (VMware) of Palo Alto, Calif. and VirtualPC by Microsoft Corp. of Redmond, Wash.

In one embodiment, a validation agent may confirm the integrity of the requesting agent. For example, in one embodiment, the validation agent may scan the requesting agent to determine if it includes any malware. In one embodiment, if the validation agent determines that the requesting agent may be compromised, the validation agent may initiate remediation mode as described below in reference to Blocks 160 & 170. In another embodiment, the validation agent may refuse to register the requesting agent. However, other actions are within the scope of the disclosed subject matter. In one embodiment, the validation agent may execute utilizing, for example, a service processor, a virtual machine monitor, or a substantially isolated partition.

Block 120 illustrates that, in one embodiment, that a memory remediation filter may be initialized. In one embodiment, the memory remediation filter may be initialized prior to the request to register the agent. It is understood that the initialization or updating of the remediation filter or filters may occur at any point; however, in the illustrative embodiment, the initialization may occur during or after the agent is registered. In one embodiment, a Configuration Agent may initialize or alter the memory remediation filters.

In one embodiment, the memory remediation filter may correlate code images with actions. In one specific example, the memory remediation filter may list a base address and an offset value which together specify a range of addresses that the action corresponds with.

For example, a first program may be stored within addresses 0x0000 to 0x1000. The memory remediation filter may correlate those addresses with a first action. Therefore, if an aberration occurs within an address between 0x0000 and 0x1000, for example, such as, address 0x0555, the memory remediation filter may specify that the first action is to be taken. Likewise, a second program may be stored within addresses 0xA000 to 0xB000 and correlated with a second action. If an aberration occurs within an address, such as, for example, address 0xA555, the memory remediation filter may specify that the second action is to be taken. It is understood that this is merely one illustrative example that is not limiting upon the disclosed matter.

In one embodiment, and action may include a simple action such as, for example, replacing the effected memory location or instruction with a “No Operation” (NOP or NOOP) instruction. For example, if it is determined that a program currently attempting a read or a write to memory has been compromised, the action in the memory remediation filter may dictate that any attempted memory access from that program be replaced with a NOOP, resulting in the inability of the compromised program to access any memory portions. This is merely one specific illustrative example to which the disclosed subject matter is not limited.

However, in other embodiments, the action may be more complex, possibly consisting of compound or cascading actions. For example, the actions may include the execution of a anti-virus program, the deletion of the compromised memory portions or programs, the quarantining of the compromised memory portions or programs, an attempted repair of the compromised memory portions or programs, the generation of a system fault, the issuing of an alert to an administer agent, or a reboot of the system. However, these are merely a few non-limiting illustrative examples.

In one embodiment, the memory remediation filter may include a table that maps addresses to actions in a one-to-one, one-to-many, many-to-one fashion or a combination thereof. In another embodiment, the filter may not use addresses as the key to determining actions, but instead other identifiers, such as, for example, a unique identifier, a non-unique identifier, a code image, or another key scheme.

In one embodiment, the memory remediation filter may be included within or as a part of a substantially isolated system partition, another system, a virtual machine monitor, a hardware component, such as, for example, a chipset or a memory controller hub (MCH). However, these are merely a few non-limiting illustrative examples to which the disclosed matter is not limited.

Block 130 illustrates that multiple embodiments may perform different actions. In one embodiment, Block 140 may be performed. In another embodiment, Blocks 150 & 155 may be performed. In a third embodiment, both paths may be performed either substantially simultaneously or sequentially. In yet another embodiment, other actions, not illustrated, may be performed in addition to or in lieu of the illustrated actions.

Block 140 illustrates that, in one embodiment, the memory may be scanned for aberrations or signs of malware. In one embodiment, the memory may be scanned periodically, or, in another embodiment, whenever a portion of the memory is altered, for example due to the loading of a program into memory. In one embodiment, a dictionary of known or suspected malware signatures may be utilized to scan the memory. In one embodiment, the scanning may occur as part of an Out-of-Band process.

Block 150 illustrates that, in another embodiment, a memory access may be attempted. In one embodiment, this may be whenever any read or write of memory is attempted. In another embodiment, the agent may be validated whenever only either a read or a write is attempted. In one embodiment, the agent may be validated when an access is attempted to any portion of memory, in another embodiment, only some portions of memory may be protected.

Block 155 illustrates that, in one embodiment, an attempt may be made to validate the integrity of the accessing agent. In one embodiment a register may exist that denotes the memory address of the instruction that is attempting to access the memory. Utilizing this Source Address Register, the validating agent may determine what program or host agent is attempting to access the memory. In one embodiment, the Source Address Register may be included within the main system processor, a service processor, or a chipset component, such as, for example a memory controller hub.

In one embodiment, the validating agent may determine if the accessing agent is registered with the validation agent. If not, in one embodiment, the accessing agent may automatically be regarded as compromised or an aberration.

In one embodiment, the validating agent may scan the accessing agent to determine if the accessing agent has been compromised or includes any form of malware or other aberration. In one embodiment, the validating agent may be able to determine the bounds of the accessing agent by utilizing the memory remediation filters. In one specific embodiment, the validation agent may be able to determine what the address of the instruction that is attempting to access the memory is. From this information, the validating agent may determine if this address corresponds with any registered host agents. In one embodiment, as part of the registration process the registering host agent may provide the memory ranges used by the host agent. The validation agent may scan these memory ranges from malware or other aberrations. In one embodiment, the validation agent may be able to determine if the accessing agent has been modified to exceed the bounds originally given when the accessing agent registered with the validating agent.

In another embodiment, if the accessing agent is registered, the validation agent may assume that the accessing agent is free of malware. In one embodiment, the validation agent may be executing utilizing or actually be a service processor, a part of a substantially isolated system partition, another system, a virtual machine monitor, a hardware component, such as, for example, a chipset or a memory controller hub (MCH).

Block 160 illustrates that, in one embodiment, if an aberration, such as, for example, the existence of malware is detected an action may be taken. In one embodiment, the path taken to arrive at Block 160 may immaterial on the action taken. In another embodiment, different actions may be taken if the aberration was detected via Block 140, Blocks 150 & 155, or a non-illustrated path.

Block 170 illustrates that, in one embodiment, the proper memory remediation filter may be executed. In one example, a memory remediation filter selected based upon the address of the affect memory portion. In another embodiment, the memory remediation filter may be selected based upon the type of detected aberration.

In one specific embodiment, if it is determined that the accessing agent is compromised, the memory remediation filter may dictate that all memory accesses originating from that access filter be disabled. Every time the accessing agent attempts to access memory, such as, for example, via a LOAD or STOR instruction, the accessing instruction may be blocked. The memory remediation filter may dictate that the LOAD/STOR instruction be replaced with a NOOP instruction. In one embodiment, the LOAD/STOR (or other offending instruction) may not be replaced in memory, but simply replaced between the instructions retrieval from memory and the execution of the instruction by the processor. In one specific embodiment, this may be done by a memory control hub (MCH). However, this is merely one specific embodiment that is not limiting on the disclosed matter.

In another embodiment, the memory remediation filter may be configured to disable malware (a compromised assessing or host agent) running within the host's memory. In yet another embodiment, the memory remediation filter may halt some or all execution on the main system processor. In one embodiment, as illustrated by Block 180, the memory remediation filter may issue an alert or request additional instructions from a network remediation agent or other agent.

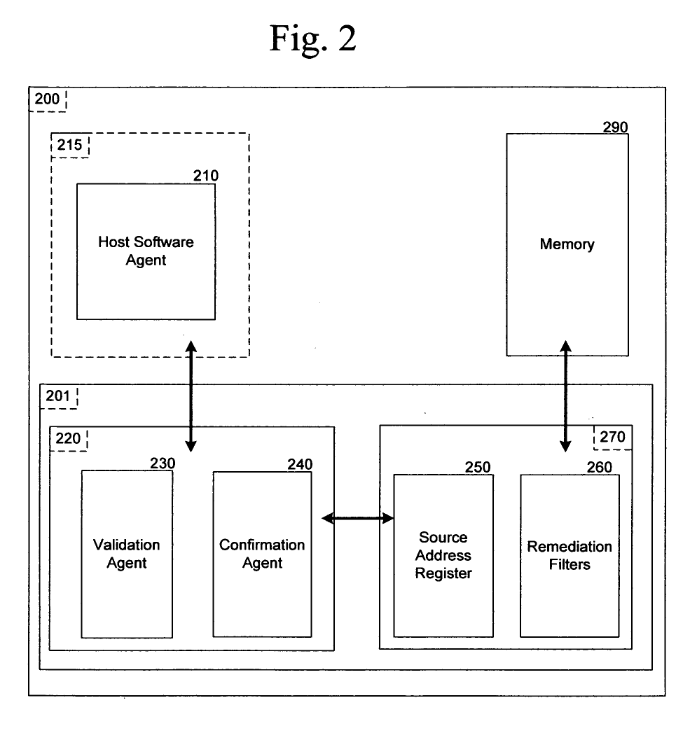

FIG. 2 is a block diagram illustrating an embodiment of an apparatus 201 and system 200 in accordance with the disclosed subject matter. In one embodiment, the system may include a memory 290, and an apparatus 201. In one embodiment the apparatus may be a chipset. In another embodiment, the apparatus may include a memory controller hub 270 and a service processor 220. In another embodiment, the apparatus may include a virtual machine monitor which may comprise some or all of the components described and illustrated as belonging to the illustrated memory controller hub and the service processor.

In one embodiment, the service processor 220 may be capable of validating the integrity of a host agent 210 or scanning the memory 290 for malware or other aberrations. In one embodiment, the service processor may include or execute a validation agent 230 and a configuration agent 240. In one embodiment, the validation agent may be capable of validating the integrity of a host agent 210 or scanning the memory 290 for malware or other aberrations as described above and illustrated by Blocks 110, 140, 150, 155 & 160. In one embodiment, the configuration agent may be capable of configuring the remediation filters 260 and performing the actions described above in reference to Blocks 120 & 170. In another embodiment, the service processor may also be able to perform the actions described above in reference to Blocks 110 and 180.

In one embodiment, memory controller hub 270 may include a remediation filter 260 that may be capable of correlating memory portions and remediation actions that may be performed when the memory portion is marked as compromised. In one embodiment, the memory remediation may include the features described above in reference to FIG. 1. In another embodiment, the memory controller hub may also include a source address register 250 that may be capable of denoting the address of any instruction that attempts to access the memory 290. The service processor 220 may be capable of utilizing the source address register to validate host agents as described above in reference to FIG. 1.

In one embodiment, the system may further include a main processor 215 that is capable of executing a host agent 210. In one embodiment, the host agent may be included within a virtual machine. In one embodiment, the host agent may be substantially isolated from the apparatus 201.

The techniques described herein are not limited to any particular hardware or software configuration; they may find applicability in any computing or processing environment. The techniques may be implemented in hardware, software, firmware or a combination thereof. The techniques may be implemented in programs executing on programmable machines such as mobile or stationary computers, personal digital assistants, and similar devices that each include a processor, a storage medium readable or accessible by the processor (including volatile and non-volatile memory and/or storage elements), at least one input device, and one or more output devices. Program code is applied to the data entered using the input device to perform the functions described and to generate output information. The output information may be applied to one or more output devices.

Each program may be implemented in a high level procedural or object oriented programming language to communicate with a processing system. However, programs may be implemented in assembly or machine language, if desired. In any case, the language may be compiled or interpreted.

Each such program may be stored on a storage medium or device, e.g. compact disk read only memory (CD-ROM), digital versatile disk (DVD), hard disk, firmware, non-volatile memory, magnetic disk or similar medium or device, that is readable by a general or special purpose programmable machine for configuring and operating the machine when the storage medium or device is read by the computer to perform the procedures described herein. The system may also be considered to be implemented as a machine-readable or accessible storage medium, configured with a program, where the storage medium so configured causes a machine to operate in a specific manner. Other embodiments are within the scope of the following claims.

While certain features of the claimed subject matter have been illustrated and described herein, many modifications, substitutions, changes, and equivalents will now occur to those skilled in the art. It is, therefore, to be understood that the appended claims are intended to cover all such modifications and changes that fall within the true spirit of the claimed subject matter.

1: A method comprising:
utilizing a substantially isolated portion of a system to monitor the validity of a memory portion; and
attempting to remediate any detected aberrations.

2: The method of claim 1, wherein utilizing a substantially isolated portion of a system to monitor the validity of a memory portion includes:
receiving a registration request from a host agent; and
initializing a memory remediation filter.

3: The method of claim 2, wherein utilizing a substantially isolated portion of a system to monitor the validity of a memory portion further includes:
validating the integrity of the host agent.

4: The method of claim 2, wherein initializing a memory remediation filter includes:
establishing a filter that correlates a memory portion with an action to be taken if the memory portion is compromised.

5: The method of claim 1, wherein attempting to remediate any detected aberrations includes:
determining if the memory portion includes an aberration; and
if so, installing a memory remediation filter in an attempt to remediate the aberration.

6: The method of claim 5, wherein determining if the memory portion includes an aberration includes:
scanning a memory portion for malware or other aberrations.

7: The method of claim 5, wherein determining if the memory portion includes an aberration includes:
noticing that an attempt has been made by an accessing agent to access a memory portion;
validating the accessing agent; and further comprising
if the accessing agent is free of aberrations, allowing the memory access to proceed.

8: The method of claim 7, wherein installing a memory remediation filter in an attempt to remediate the aberration includes:
if the accessing agent includes an aberration, installing a memory remediation filter that denies access from the accessing agent to memory.

9: The method of claim 8, wherein installing a memory remediation filter that denies access from the accessing agent to memory includes:
replacing any memory access instructions from the compromised accessing agent with a no-operation instruction.

10: The method of claim 5, further comprising:
informing an agent on a network that the system is in remediation mode.

11: An apparatus comprising:
a validation agent capable of determining whether or not a memory portion is compromised, and
at least one memory remediation filter capable of correlating memory portions and remediation actions to be performed when a memory portion is determined to be compromised; and
wherein the apparatus is capable of utilizing the memory remediation filter to attempt to remediate any compromised memory portion.

12: The apparatus of claim 11, wherein the validation agent is capable of receiving a registration request from a host agent; and
further comprising a configuration agent capable of initializing a memory remediation filter.

13: The apparatus of claim 12, wherein the validation agent is capable of validating the integrity of the host agent.

14: The apparatus of claim 11, wherein attempting to remediate any compromised memory portions includes:
determining if the memory portion includes an aberration; and
if so, installing a memory remediation filter in an attempt to remediate the aberration.

15: The apparatus of claim 14, wherein determining if the memory portion includes an aberration includes:
scanning a memory portion for malware or other aberrations.

16: The apparatus of claim 14, wherein determining if the memory portion includes an aberration includes:
noticing that an attempt has been made by an accessing agent to access a memory portion;
validating the accessing agent; and further comprising
if the accessing agent is free of aberrations, allowing the memory access to proceed.

17: The apparatus of claim 16, wherein installing a memory remediation filter in an attempt to remediate the aberration includes:
if the accessing agent includes an aberration, installing a memory remediation filter that denies access from the accessing agent to memory.

18: The apparatus of claim 17, wherein installing a memory remediation filter that denies access from the accessing agent to memory includes:
replacing any memory access instructions from the compromised accessing agent with a no-operation instruction.

19: The apparatus of claim 16, wherein the apparatus further includes a source address register capable of identifying the source of a memory access request; and
wherein validating the accessing agent includes utilizing the source address register to validate the accessing agent.

20: The apparatus of claim 11, wherein the apparatus includes a virtual machine monitor.

21: A system comprising:
a memory; and
a substantially isolated partition having:
a validation agent capable of determining whether or not a memory portion is compromised, and
at least one memory remediation filter capable of correlating memory portions and remediation actions to be performed when a memory portion is determined to be compromised; and
wherein the apparatus is capable of utilizing the memory remediation filter to attempt to remediate any compromised memory portion.

22: The system of claim 21, wherein the substantially isolated partition includes:
a service processor having the validation agent; and
a memory controller hub having the at least one memory remediation filter.

23: The system of claim 21, wherein the system further includes at least one virtual machine capable of executing a host agent; and
the substantially isolated partition includes a virtual machine monitor capable of monitoring the virtual machines.

24: The system of claim 21, wherein the validation agent is capable of receiving a registration request from a host agent; and
the isolated partition further includes a configuration agent capable of initializing a memory remediation filter.

25: The system of claim 24, wherein the validation agent is capable of validating the integrity of the host agent.

26: The system of claim 21, wherein attempting to remediate any compromised memory portions includes:
determining if the memory portion includes an aberration; and
if so, installing a memory remediation filter in an attempt to remediate the aberration.

27: The system of claim 26, wherein determining if the memory portion includes an aberration includes:
scanning a memory portion for malware or other aberrations.

28: The system of claim 26, wherein determining if the memory portion includes an aberration includes:
noticing that an attempt has been made by an accessing agent to access a memory portion;
validating the accessing agent; and further comprising
if the accessing agent is free of aberrations, allowing the memory access to proceed.

29: The system of claim 28, wherein installing a memory remediation filter in an attempt to remediate the aberration includes:
if the accessing agent includes an aberration, installing a memory remediation filter that denies access from the accessing agent to memory.

30: The system of claim 28, wherein the substantially isolated partition further includes a source address register capable of identifying the source of a memory access request; and
wherein validating the accessing agent includes utilizing the source address register to validate the accessing agent.

31: An article comprising:
a tangible medium having a plurality of machine accessible instructions, wherein when the instructions are executed, the instructions provide for:
utilizing a substantially isolated portion of a system to monitor the validity of a memory portion; and
attempting to remediate any detected aberrations.

32: The article of claim 30, wherein the tangible medium includes any tangible medium of expression as understood under 17 U.S.C. § 102 (2005).
